(19) United States
(12) Patent Application Publication
(10) Pub. No.: US 2024/0113604 A1
(43) Pub. Date: Apr. 4, 2024

(54) METHOD OF MANUFACTURING A ROTOR ASSEMBLY

(71) Applicant: BorgWarner Inc., Auburn Hills, MI (US)

(72) Inventors: Mitsuru Ishihara, Kanagawa (JP); Andreas WP Mayer, Clarkston, MI (US); Calahan B. Campton, Royal Oak, MI (US)

(21) Appl. No.: 17/957,110

(22) Filed: Sep. 30, 2022

(51) Int. Cl. H02K 15/03; H02K 1/04; H02K 1/276; H02K 1/28; H02K 7/16; H02K 21/14

(52) U.S. Cl. CPC H02K 15/03; H02K 1/04; H02K 1/276; H02K 1/28; H02K 7/16; H02K 21/14

(57) ABSTRACT

A method of manufacturing a rotor assembly for an electric motor is disclosed. The rotor assembly includes a lamination stack extending along an axis, a plurality of magnets including a first and second magnet each coupled to the lamination stack, and a plurality of pole pieces including a first pole piece spaced from the lamination stack and separate from the lamination stack. The rotor assembly also includes a plurality of spacers including a first spacer spaced from the lamination stack. The method includes the step of disposing the first magnet and the second magnet between the lamination stack and the first pole piece. The method also includes the step of disposing the first spacer between the lamination stack and the first pole piece to reduce flux leakage between the lamination stack and the first pole piece.

### BACKGROUND OF THE INVENTION

### 1. Field of the Invention

The invention generally relates to a method of manufacturing a rotor assembly for an electric motor, and to a method of manufacturing an electric motor including the rotor assembly.

### 2. Description of the Related Art

Electric motors include a rotor assembly and a stator disposed about the rotor assembly. Rotor assemblies commonly include a shaft, a lamination stack disposed about the shaft, and a plurality of pole pieces spaced radially from the lamination stack. Typically, permanent magnets are embedded into the rotor assembly, commonly between the lamination stack and plurality of pole pieces. Stators commonly include coil windings, and energization of the coil windings in the stator generates magnetic flux which interacts with the permanent magnets to impart a force which causes the rotor assembly to rotate.

Typically, the lamination stack and the plurality of pole pieces are physically connected to one another through a plurality of bridges, thus forming what is commonly referred to as a bridged rotor assembly. Each bridge is unitary with both the lamination stack and one of the plurality of pole pieces and is typically comprised of the same material as the lamination stack and the plurality of pole pieces. The bridge prevents the plurality of pole pieces from moving away from the lamination stack due to centrifugal forces imparted on the plurality of pole pieces during rotation of the rotor assembly.

However, the magnetic flux generated by the coil windings of the stator is disrupted, or leaked, by the bridge so that a portion of the magnetic flux is directed toward the lamination stack and away from the plurality of magnets. As such, any magnetic flux that leaks through the bridge fails to interact with the permanent magnets, thus lowering the force imparted to the rotor assembly, and also lowering the efficiency of the electric motor. To minimize leakage of flux through the bridge, the bridge is typically designed to be relatively thin. However, the centrifugal forces imparted to the plurality of pole pieces by rotation of the rotor assembly are also imparted to the bridge. These centrifugal forces imparted to the bridge result in a concentration of stress on the bridge and risk structural failure of the bridge, particularly when the bridge has been designed to be relatively thin.

As such, there remains a need to provide a method of manufacturing an improved rotor assembly for an electric motor.

### SUMMARY OF THE INVENTION AND ADVANTAGES

A method of manufacturing a rotor assembly for an electric motor is disclosed. The rotor assembly includes a lamination stack extending along an axis, a plurality of magnets including a first and second magnet each coupled to the lamination stack, and a plurality of pole pieces including a first pole piece spaced from the lamination stack and separate from the lamination stack. The rotor assembly also includes a plurality of spacers including a first spacer spaced from the lamination stack.

The method includes the step of disposing the first magnet and the second magnet between the lamination stack and the first pole piece. The method also includes the step of disposing the first spacer between the lamination stack and the first pole piece to reduce flux leakage between the lamination stack and the first pole piece.

The first spacer prevents disruption, or leakage, or magnetic flux between the first pole piece and the lamination stack. As such, the magnetic flux is ensured to be directed to the first and second magnets to interact with the first and second magnets and efficiently impart a force to the rotor assembly to rotate the rotor assembly.

Each pole piece of the plurality of pole pieces is separate from the lamination stack, thus forming a bridgeless arrangement of the pole pieces and the lamination stack. As such, centrifugal forces imparted to the plurality of pole pieces by rotation of the rotor assembly are not also imparted to any bridge connecting the plurality of pole pieces and the lamination stack. Thus, the bridgeless arrangement of the pole pieces and the lamination stack eliminates concern for centrifugal forces imparting a force on any bridge, resulting in a concentration of stress on any bridge, and potentially resulting in structural failure of any bridge. Moreover, the method provides an inexpensive, reproducible, timely, and simple manufacturing process to produce the rotor assembly including the above-mentioned qualities.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a flowchart depicting a method of manufacturing a rotor assembly according to the invention;

FIG. 2 is a perspective view of the rotor assembly;

FIG. 3 is a cross-sectional view partially in phantom of the rotor assembly of FIG. 2, with the rotor assembly including a first end cap, a second end cap, and a plurality of rods extending therebetween;

FIG. 4 is another cross-sectional view of the rotor assembly of FIG. 2, with the rotor assembly including a lamination stack, a plurality of pole pieces, a plurality of magnets, and a sleeve including an outer sleeve body and a plurality of spacers;

FIG. 5 is a perspective view of the first end cap, the second end cap, and the plurality of rods extending therebetween;

FIG. 6 is a perspective view of another embodiment of the rotor assembly;

FIG. 7A is a cross-sectional view of one embodiment of the rotor assembly shown in FIG. 6, with the rotor assembly including the lamination stack, the plurality of pole pieces, the plurality of magnets, and the plurality of spacers;

FIG. 7B is an expanded view of FIG. 7A;

FIG. 8 is a cross-sectional view of another embodiment of the rotor assembly shown in FIG. 6;

FIG. 9 is a perspective view of an electric motor including the rotor assembly; and

FIG. 10 is a perspective view partially in phantom of an electric drive unit including the electric motor of FIG. 9.

### DETAILED DESCRIPTION OF THE INVENTION

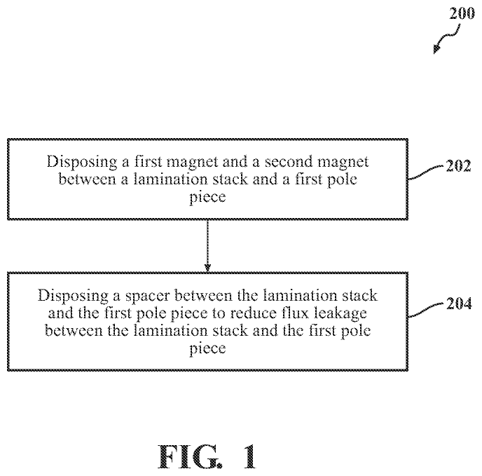

With reference to the Figures, wherein like numerals indicate like parts throughout the several views, a method of manufacturing a rotor assembly 20 for an electric motor 22 is shown in FIG. 1. The rotor assembly 20 includes a lamination stack 24 extending along an axis A1, a plurality of magnets 26 including a first magnet 28 and a second magnet 30 each coupled to the lamination stack 24, and a plurality of pole pieces 32 including a first pole piece 34 spaced from the lamination stack 24 and separate from the lamination stack 24. The rotor assembly 20 also includes a plurality of spacers 36 including a first spacer 38 spaced from the lamination stack 24. Although not required, the first magnet 28 and the second magnet 30 may be disposed between the lamination stack 24 and the first pole piece 34. Moreover, the rotor assembly 20 may also include a shaft 40 extending along, and rotatable about, the axis A1. The lamination stack 24 may be coupled to the shaft 40, and each pole piece 32 of the plurality of pole pieces 32, including the first pole piece 34, may be spaced radially outward from the shaft 40.

The method 200 includes the step 202 of disposing the first magnet 28 and the second magnet 30 between the lamination stack 24 and the first pole piece 34. The method also includes the step 204 of disposing the first spacer 38 between the lamination stack 24 and the first pole piece 34 to reduce flux leakage between the lamination stack 24 and the first pole piece 34. It is to be appreciated that the step 202 of disposing the first magnet 28 and the second magnet 30 between the lamination stack 24 and the first pole piece 34 may be accomplished manually by an operator or may be automated by a robot. It is also to be appreciated that the step 204 of disposing the first spacer 38 between the lamination stack 24 and the first pole piece 34 may be accomplished manually by an operator or may be automated by a robot.

The first spacer 38 prevents disruption, or leakage, or magnetic flux between the first pole piece 34 and the lamination stack 24. As such, the magnetic flux is ensured to be directed to the first magnet 28 and to the second magnet 30 to interact with the first magnet 28 and the second magnet 30 and efficiently impart a force to the rotor assembly 20 to rotate the rotor assembly 20.

Each pole piece 32 of the plurality of pole pieces 32 is separate from the lamination stack 24, thus forming a bridgeless arrangement of the pole pieces 32 and the lamination stack 24. In other words, each pole piece 32 of the plurality of pole pieces 32 may be separate components from the lamination stack 24, and the plurality of pole pieces 32 and the lamination stack 24 are not connected to one another through a bridging material. As such, centrifugal forces imparted to the plurality of pole pieces 32 by rotation of the rotor assembly 20 are not also imparted to any bridge connecting the plurality of pole pieces 32 and the lamination stack 24. Thus, the bridgeless arrangement of the plurality of pole pieces 32 and the lamination stack 24 eliminates concern for centrifugal forces imparting a force on any bridge, resulting in a concentration of stress on any bridge, and potentially resulting in structural failure of any bridge. Moreover, the method 200 provides an inexpensive, reproducible, timely, and simple manufacturing process to produce the rotor assembly 20 including the above-mentioned qualities.

Although the benefits of the first spacer 38 have been described with reference to the first pole piece 34, the first magnet 28, the second magnet 30, and the lamination stack 24, it is to be appreciated that these benefits may apply equally to all other spacers 36 of the plurality of spacers 36, all other pole pieces 32 of the plurality of pole pieces 32, all other magnets 26 of the plurality of magnets 26, and the lamination stack 24. Each spacer 36 and pole piece 32 may have the characteristics of the first spacer 38 and the first pole piece 34 as described herein. More specifically, the plurality of spacers 36 may prevent disruption, or leakage, of magnetic flux between the plurality of pole pieces 32 and the lamination stack 24. As such, the magnetic flux is ensured to be directed to the plurality of magnets 26 to interact with the plurality of magnets 26 and efficiently impart a force to the rotor assembly 20 to rotate the rotor assembly 20.

Although not required, the step 204 of disposing the first spacer 38 between the lamination stack 24 and the first pole piece 34 includes disposing the first spacer 38 such that the first spacer 38 extends at least to the first magnet 28. Moreover, the step 204 of disposing the first spacer 38 between the lamination stack 24 and the first pole piece 34 may include disposing the first spacer 38 such that the first spacer 38 is disposed between the first magnet 28 and the second magnet 30. The step 204 of disposing the first spacer 38 between the lamination stack 24 and the first pole piece 34 may result in the first spacer 38 extending radially inward toward the first magnet 28 and also extending past the first magnet 28, optionally encapsulating at least a portion of the first magnet 28, to then be disposed between the first magnet 28 and the second magnet 30.

The lamination stack 24 may be manufactured from a plurality of laminations which are fixed to one another, in non-limiting examples by interlocking, welding, clamping, and/or bonding. To improve manufacturability of the lamination stack 24, each lamination of the lamination stack 24 may be the same as every other lamination in the lamination stack 24.

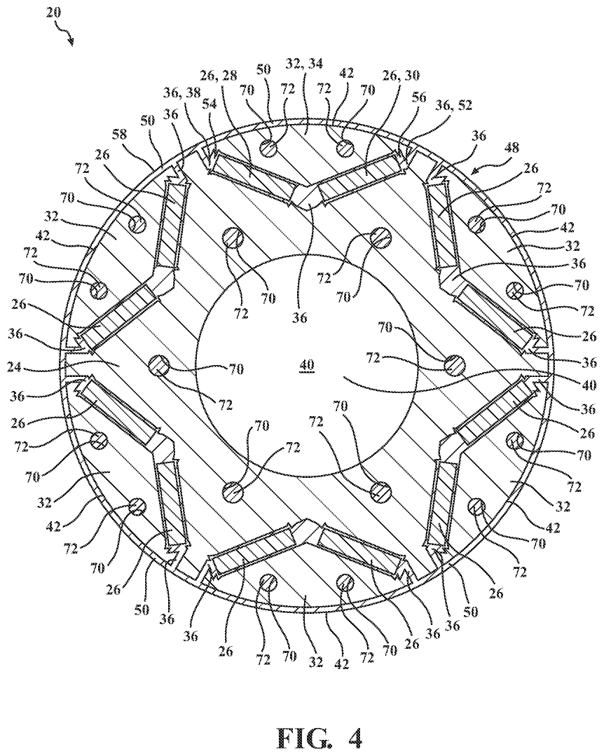

Each magnet of the plurality of magnets 26, including the first magnet 28 and the second magnet 30, may be a permanent magnet. The first magnet 28 and the second magnet 30 may be configured to form a V-shape, as shown in FIGS. 4 and 7A-8. Each pole piece 32 of the plurality of pole pieces 32, including the first pole piece 34, may be comprised of metals and/or metalloids including, but not limited to, iron, cobalt, nickel, silicon, manganese, aluminum, steel including electrical steel, and combinations thereof. The lamination stack 24 may be comprised of metals and/or metalloids including, but not limited to, iron, cobalt, nickel, silicon, manganese, aluminum, steel including electrical steel, and combinations thereof. Although not required, it is to be appreciated that the plurality of pole pieces 32 may be comprised of the same metal and/or metalloids that the lamination stack 24 is comprised of.

Although not required, the step 202 of disposing the first magnet 28 and the second magnet 30 between the lamination stack 24 and the first pole piece 34 may precede the step 204 of disposing the first spacer 38 between the lamination stack 24 and the first pole piece 34. It is to be appreciated that the step 204 of disposing the first spacer 38 between the lamination stack 24 and the first pole piece 34 may follow immediately after the step 202 of disposing the first magnet 28 and the second magnet 30 between the lamination stack 24 and the first pole piece 34, or there may be intervening step(s) therebetween.

The method 200 may further include the step of disposing the shaft 40 within the lamination stack 24 such that the shaft 40 extends along the axis A1. Although not required, the step of disposing the shaft 40 within the lamination stack 24 may come after the step 204 of disposing the first spacer 38 between the lamination stack 24 and the first pole piece 34. It is to be appreciated that the step of disposing the shaft 40 within the lamination stack 24 may follow immediately after the step 204 of disposing the first spacer 38 between the lamination stack 24 and the first pole piece 34, or there may be intervening step(s) therebetween.

The first spacer 38 may comprise a polymeric material. In non-limiting examples, the polymeric material of the first spacer 38 may be a thermoplastic, a thermoset, or an elastomer. The polymeric material of the first spacer 38 may be an engineering plastic. More specifically, the polymeric material of the first spacer 38 may be any polyalkene or polyolefin including copolymers and terpolymers thereof such as polyethylene including high-density polyethylene (HDPE) and low-density polyethylene (LDPE), polypropylene (PP), polybutylene and polybutylene terephthalate (PBTR), acrylics such as acrylonitrile butadiene styrene (ABS) or polymethylmethacrylate (PMMA), polyoxymethylene (POM) or any acetal copolymers or acetal terpolymers, polyketones, polyetherketones, and/or polyaryletherketones such as polyetheretherketone (PEEK) and polyetherketoneketone (PEKK), polyetherimide (PEI), polyimides, polyvinylchloride (PVC), polyphenylene sulfide (PPS), polyphenylene oxide (PPO), polysulphone (PSU), polytetrafluoroethylene (PTFE), polyamides including polyphthalamide, polycarbonates, urethanes, epoxies, and thermoplastic elastomers (TPE).

The first spacer 38 may also comprise a first composition including any of the polymeric materials detailed herein as well as optional fillers and/or additives, such as plasticizers, carbon including carbon fiber, ceramic materials and/or minerals including calcium carbonate, silica, clay, and kaolin, fibers including glass fibers, carbon fibers, aramid fibers, basalt fibers, and paper fibers, stabilizers including oxidation stabilizers, ultraviolet (UV) stabilizers, heat stabilizers, light absorbers, strengtheners, acid scavengers, metal deactivators, and flame retardants including, for example, aluminum hydroxide, phosphorus compounds, and brominated compounds.

Although not required, the polymeric material of the first spacer 38 may be molded, such as over-molded, insert molded, injection molded, compression molded, and thermoformed. The step 204 of disposing the first spacer 38 between the lamination stack 24 and the first pole piece 34 may include molding the first spacer 38 such that the first spacer 38 is disposed between the lamination stack 24 and the first pole piece 34. It is to be appreciated that molding the first spacer 38 such that the first spacer 38 is disposed between the lamination stack 24 and the first pole piece 34 may include any of molding-in-place, over-molding, insert-molding, injection molding, compression molding, and thermoforming.

Each pole piece 32 of the plurality of pole pieces 32, including the first pole piece 34, has an outer pole surface 42 facing away from the axis A1. The first pole piece 34 has a first circumferential end 44 and a second circumferential end 46 spaced circumferentially from the first circumferential end 44. The outer pole surface 42 of the first pole piece 34 extends between the first and second circumferential ends 44, 46. The step 204 of disposing the first spacer 38 between the lamination stack 24 and the first pole piece 34 may include disposing the first spacer 38 circumferentially between the first circumferential end 44 and the lamination stack 24.

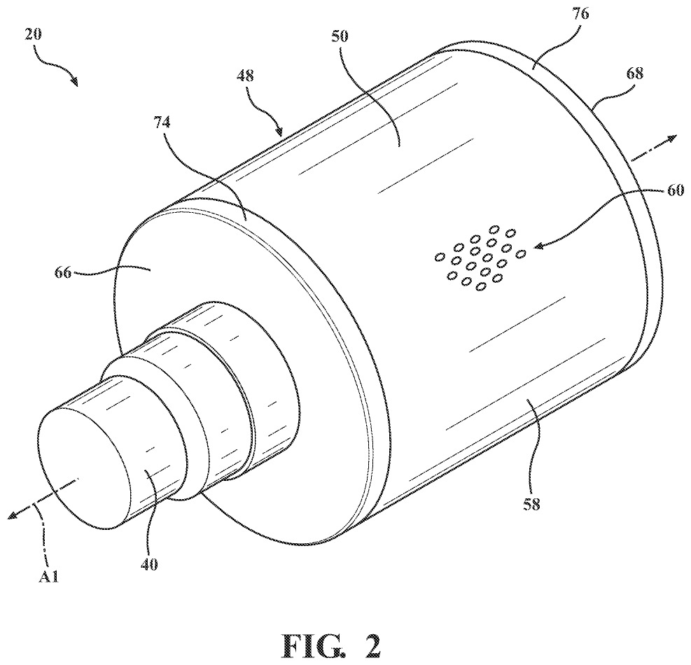

As shown in FIGS. 2-4, the rotor assembly 20 may further include a sleeve 48 including an outer sleeve body 50 and the plurality of spacers 36. In other words, the plurality of spacers 36 may be incorporated into the sleeve 48 along with the outer sleeve body 50. The outer sleeve body 50 of the sleeve 48 is disposed about the outer pole surface 42 of each pole piece 32 of the plurality of pole pieces 32 to retain each of the plurality of pole pieces 32 with respect to the lamination stack 24. The plurality of spacers 36 extends from the outer sleeve body 50 radially inward toward the shaft 40. The first spacer 38 may extend from the outer sleeve body 50 radially inward toward the shaft 40. The plurality of spacers 36 includes the first spacer 38. Additionally, although not required, the plurality of spacers 36 may include a second spacer 52 extending radially inward from the outer sleeve body 50 toward the shaft 40. The first spacer 38 and the second spacer 52 are disposed between the first pole piece 34 and the lamination stack 24 to reduce flux leakage between the first pole piece 34 and the lamination stack 24.

The outer sleeve body 50 retains the first pole piece 34 with respect to the lamination stack 24 thereby preventing the first pole piece 34 from moving away from the lamination stack 24 when centrifugal forces are imparted on the first pole piece 34 by rotation of the rotor assembly 20. Moreover, the outer sleeve body 50, the first spacer 38, and optionally the second spacer 52 prevent disruption, or leakage, of magnetic flux between the first pole piece 34 and the lamination stack 24. As such, the magnetic flux is ensured to be directed to the first magnet 28 and to the second magnet 30 to interact with the first magnet 28 and the second magnet 30 and efficiently impart a force to the rotor assembly 20 to rotate the rotor assembly 20.

Although the benefits of the outer sleeve body 50, the first spacer 38, and optionally the second spacer 52 have been described with reference to the first pole piece 34, the first magnet 28, the second magnet 30, and the lamination stack 24, it is to be appreciated that these benefits may apply equally to all other spacers 36 of the plurality of spacers 36, all other pole pieces 32 of the plurality of pole pieces 32, all other magnets 26 of the plurality of magnets 26, and the lamination stack 24. Each spacer 36 and pole piece 32 may have the characteristics of the first spacer 38, the second spacer 52, and the first pole piece 34 as described herein. More specifically, the outer sleeve body 50 may retain each of the plurality of pole pieces 32 with respect to the lamination stack 24 thereby preventing the plurality of pole pieces 32 from moving away from the lamination stack 24 when centrifugal forces are imparted on each pole piece 32 by rotation of the rotor assembly 20. Moreover, the outer sleeve body 50 and the plurality of spacers 36 prevents disruption, or leakage, of magnetic flux between the plurality of pole pieces 32 and the lamination stack 24. As such, the magnetic flux is ensured to be directed to the plurality of magnets 26 to interact with the plurality of magnets 26 and efficiently impart a force to the rotor assembly 20 to rotate the rotor assembly 20.

The step 204 of disposing the first spacer 38 between the lamination stack 24 and the first pole piece 34 may further include coupling the sleeve 48 to the lamination stack 24. Coupling the sleeve 48 to the lamination stack 24 may include disposing the outer sleeve body 50 about the outer pole surface 42 of each pole piece 32 of the plurality of pole pieces 32 to retain each of the plurality of pole pieces 32 with respect to the lamination stack 24. Moreover, the method 200 may further include the step of disposing the second spacer 52 between the lamination stack 24 and the first pole piece 34.

Although not required, the second spacer 52 may extend at least to the second magnet 30. The second spacer 52 may also be disposed between the first magnet 28 and the second magnet 30. It is to be appreciated that the second spacer 52 may extend from the outer sleeve body 50 radially inward toward the second magnet 30 and may also extend past the second magnet 30, optionally encapsulating at least a portion of the second magnet 30, to then be disposed between the first magnet 28 and the second magnet 30. It is further to be appreciated that both the first spacer 38 and the second spacer 52 may be disposed between the first magnet 28 and the second magnet 30, and may be fixed to one another, made unitary, or otherwise joined between the first magnet 28 and the second magnet 30.

Although not required, the sleeve 48 may comprise a polymeric material. It is to be appreciated that the sleeve 48 may comprise the same polymeric material as the first spacer 38. In non-limiting examples, the polymeric material of the sleeve 48 may be a thermoplastic, a thermoset, or an elastomer. The polymeric material of the sleeve 48 may be an engineering plastic. More specifically, the polymeric material of the sleeve 48 may be, but is not limited to, any polyalkene or polyolefin including copolymers and terpolymers thereof such as polyethylene including high-density polyethylene (HDPE) and low-density polyethylene (LDPE), polypropylene (PP), polybutylene and polybutylene terephthalate (PBTR), acrylics such as acrylonitrile butadiene styrene (ABS) or polymethylmethacrylate (PMMA), polyoxymethylene (POM) or any acetal copolymers or acetal terpolymers, polyketones, polyetherketones, and/or polyaryletherketones such as polyetheretherketone (PEEK) and polyetherketoneketone (PEKK), polyetherimide (PEI), polyimides, polyvinylchloride (PVC), polyphenylene sulfide (PPS), polyphenylene oxide (PPO), polysulphone (PSU), polytetrafluoroethylene (PTFE), polyamides including polyphthalamide, polycarbonates, urethanes, epoxies, and thermoplastic elastomers (TPE).

The sleeve 48 may also comprise the first composition including any of the polymeric materials detailed herein as well as optional fillers and/or additives, such as plasticizers, carbon including carbon fiber, ceramic materials and/or minerals including calcium carbonate, silica, clay, and kaolin, fibers including glass fibers, carbon fibers, aramid fibers, basalt fibers, and paper fibers, stabilizers including oxidation stabilizers, ultraviolet (UV) stabilizers, heat stabilizers, light absorbers, strengtheners, acid scavengers, metal deactivators, and flame retardants including aluminum hydroxide, phosphorus compounds, and brominated compounds.

Although not required, the polymeric material of the sleeve 48 may be molded, such as over-molded, insert molded, injection molded, compression molded, and thermoformed. The step 204 of disposing the first spacer 38 between the lamination stack 24 and the first pole piece 34 may include molding the sleeve 48 such that the first spacer 38 is disposed between the lamination stack 24 and the first pole piece 34. Moreover, the step of disposing the second spacer between the lamination stack 24 and the first pole piece 34 may include molding the sleeve 48 such that the second spacer 52 is disposed between the lamination stack 24 and the first pole piece 34. It is to be appreciated that molding the sleeve 48 such that either, or both, of the first spacer 38 and the second spacer 52 are disposed between the lamination stack 24 and the first pole piece 34 may include any of molding-in-place, over-molding, insert-molding, injection molding, compression molding, and thermoforming.

The outer sleeve body 50 of the sleeve 48 and the plurality of spacers 36 of the sleeve 48 may be unitary. In other words, the outer sleeve body 50 of the sleeve 48 and the plurality of spacers 36 of the sleeve 48 may be integral with one another (i.e., one-piece). The outer sleeve body 50 of the sleeve 48 and the plurality of spacers 36 of the sleeve 48 may be integrally formed together to be unitary or may be formed separately and later joined to become unitary. The method 200 may include the step of forming the outer sleeve body 50 and the plurality of spacers 36 such that the outer sleeve body 50 and the plurality of spacers 36 are integral with one another. The step of forming the outer sleeve body 50 and the plurality of spacers 36 such that the outer sleeve body 50 and the plurality of spacers 36 are integral with one another may be concurrent with (i.e., at the same time as) the step 204 of disposing the first spacer 38 between the lamination stack 24 and the first pole piece 34.

Moreover, as shown in FIG. 4, the first pole piece 34 may define a first recess 54, and the first spacer 38 may be disposed at least partially in the first recess 54. In the embodiments including the sleeve 48, the first spacer 38 being disposed at least partially in the first recess 54 further couples the sleeve 48 and the first pole piece 34. The first spacer 38 may have a hooked configuration and may extend radially away from the shaft 40 to be disposed in the first recess 54 of the first pole piece 34. The first recess 54 may be disposed adjacent to the first magnet 28. The method 200 may further include the step of disposing the first spacer 38 at least partially in the first recess 54. The step of disposing the first spacer 38 at least partially in the first recess 54 may be concurrent with (i.e., at the same time as) the step 204 of disposing the first spacer 38 between the lamination stack 24 and the first pole piece 34.

As also shown in FIG. 4, the first pole piece 34 may define a second recess 56, and the second spacer 52 may be disposed at least partially in the second recess 56. In the embodiments including the sleeve 48, the second spacer 52 being disposed at least partially in the second recess 56 further couples the sleeve 48 and the first pole piece 34. The second spacer 52 may have a hooked configuration and may extend radially away from the shaft 40 to be disposed in the second recess 56 of the first pole piece 34. The second recess 56 may be disposed adjacent to the second magnet 30. The method 200 may further include the step of disposing the second spacer 52 at least partially in the second recess 56. The step of disposing the second spacer 52 at least partially in the second recess 56 may be concurrent with (i.e., at the same time as) the step 204 of disposing the first spacer 38 between the lamination stack 24 and the first pole piece 34.

The outer sleeve body 50 has an outer sleeve surface 58 facing away from the axis A1. The outer sleeve surface 58 is in contact with air during rotation of the rotor assembly 20. The outer sleeve surface 58 may be smooth to reduce air friction. Alternatively, the outer sleeve body 50 may include an aerodynamic feature 60 indented into the outer sleeve surface 58 to reduce air friction. The aerodynamic feature 60 may include, but is not limited to, a groove, a series of grooves, a dimple, or a series of dimples. The method 200 may include forming the sleeve 48 such that the outer sleeve surface 58 of the sleeve 48 includes the aerodynamic feature 60 indented into the outer sleeve surface 58.

The lamination stack 24 extends along the axis A1 between a first lamination stack end 62 and a second lamination stack end 64. The rotor assembly 20 may further include a first end cap 66 adjacent to the first lamination stack end 62 and a second end cap 68 adjacent to the second lamination stack end 64. The first end cap 66 and the second end cap 68 assist in preventing the plurality of magnets 26 from being dispelled from between the plurality of pole pieces 32 and the lamination stack 24.

The first end cap 66 and the second end cap 68 comprise a polymeric material. In the embodiments including the first spacer 38 and optionally the sleeve 48 comprising a polymeric material, the first end cap 66 comprising a polymeric material, and the second end cap 68 comprising a polymeric material, it is to be appreciated that these polymeric materials may be the same as each other or may be different from one another. In non-limiting examples, the polymeric material of the first end cap 66 and the second end cap 68 may be a thermoplastic, a thermoset, or an elastomer. The polymeric material of the first end cap 66 and the second end cap 68 may be an engineering plastic.

More specifically, the polymeric material of the first end cap 66 and the second end cap 68 may be, but is not limited to, any polyalkene or polyolefin including copolymers and terpolymers thereof such as polyethylene including high-density polyethylene (HDPE) and low-density polyethylene (LDPE), polypropylene (PP), polybutylene and polybutylene terephthalate (PBTR), acrylics such as acrylonitrile butadiene styrene (ABS) or polymethylmethacrylate (PMMA), polyoxymethylene (POM) or any acetal copolymers or acetal terpolymers, polyketones, polyetherketones, and/or polyaryletherketones such as polyetheretherketone (PEEK) and polyetherketoneketone (PEKK), polyetherimide (PEI), polyimides, polyvinylchloride (PVC), polyphenylene sulfide (PPS), polyphenylene oxide (PPO), polysulphone (PSU), polytetrafluoroethylene (PTFE), polyamides including polyphthalamide, polycarbonates, urethanes, epoxies, and thermoplastic elastomers (TPE).

Although not required, the polymeric material of the first end cap 66 and the second end cap 68 may be molded, such as over-molded, insert molded, injection molded, compression molded, and thermoformed. The method 200 may further include the step of molding the first end cap 66 and the second end cap 68. It is to be appreciated that molding the first end cap 66 and the second end cap 68 may include any of molding-in-place, over-molding, insert-molding, injection molding, compression molding, and thermoforming.

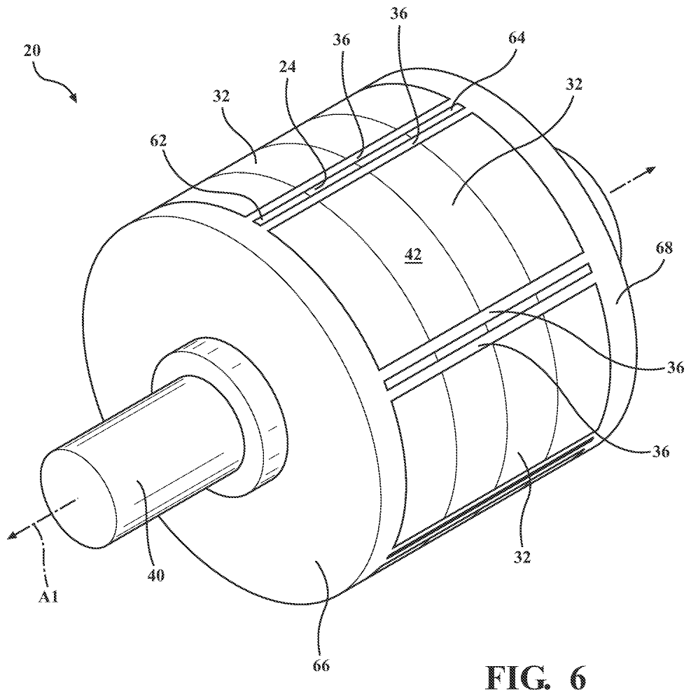

The step of molding the first end cap 66 and the second end cap 68 may be concurrent with (i.e., at the same time as) the step of molding the first spacer 38 such that the first end cap 66 and the second end cap 68 are unitary with the first spacer 38. The first end cap 66 and the second end cap 68 may be unitary with the first spacer 38, as shown in FIG. 6. In other words, the first end cap 66, the second end cap 68, and the first spacer 38 may be integral with one another, i.e., one-piece. In this embodiment, the first end cap 66 and the second end cap 68 may have the first composition (i.e., the same composition as the first spacer 38). It is also to be appreciated that the step of molding the first end cap 66 and the second end cap 68 may be concurrent with (i.e., at the same time as) the step 204 of disposing the first spacer 38 between the lamination stack 24 and the first pole piece 34.

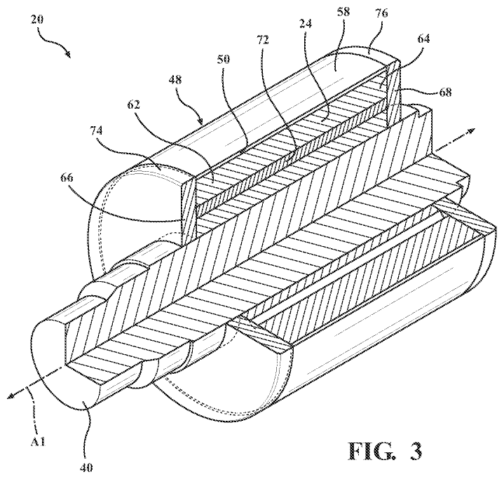

Alternatively, the step of molding the first end cap 66 and the second end cap 68 may be separate from (i.e., at different times as) the step of molding the first spacer 38. It is to be appreciated that the step of molding the first end cap 66 and the second end cap 68 may follow the step of molding the first spacer 38, or the step of molding the first end cap 66 and the second end cap 68 may precede the step of molding the first spacer 38. The first end cap 66 and the second end cap 68 may be separate components from the first spacer 38, as shown in FIG. 3. The first end cap 66 and the second end cap 68 may have a second composition different from the first composition of the first spacer 38. It is also to be appreciated that the step of molding the first end cap 66 and the second end cap 68 may be separate from (i.e., at different times as) the step 204 of disposing the first spacer 38 between the lamination stack 24 and the first pole piece 34.

The second composition of the first end cap 66 and the second end cap 68 may include any of the polymeric materials detailed herein as well as optional fillers and/or additives, such as plasticizers, carbon including carbon fiber, ceramic materials and/or minerals including calcium carbonate, silica, clay, and kaolin, fibers including glass fibers, carbon fibers, aramid fibers, basalt fibers, and paper fibers, stabilizers including oxidation stabilizers, ultraviolet (UV) stabilizers, heat stabilizers, light absorbers, strengtheners, acid scavengers, metal deactivators, and flame retardants including aluminum hydroxide, phosphorus compounds, and brominated compounds. In one embodiment, the second composition includes a thermoplastic and a filler encapsulated by the thermoplastic. In this embodiment, the filler may include carbon fiber.

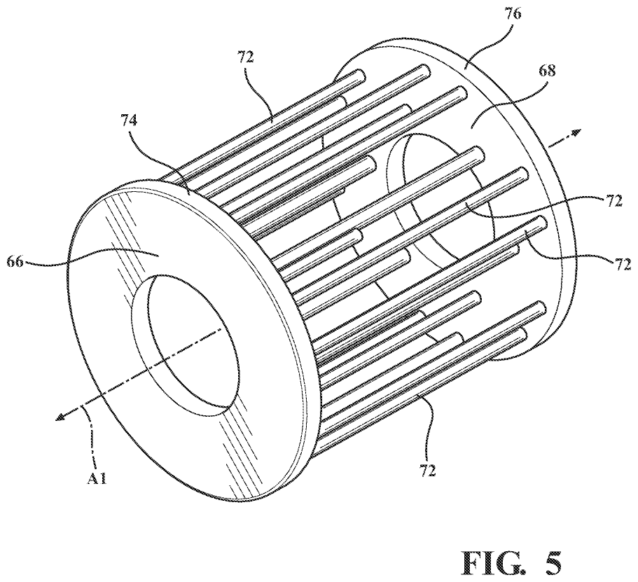

The lamination stack 24 may define a plurality of channels 70 between the first lamination stack end 62 and the second lamination stack end 64. The rotor assembly 20 may further include a plurality of rods 72 disposed in the plurality of channels 70, as shown in FIGS. 3, 4 and 7A-8. It is to be appreciated that one rod 72 of the plurality of rods 72 may correspond to, and be disposed in, one channel of the plurality of channels 70. Although not required, the plurality of rods 72 may be unitary with the first end cap 66 and the second end cap 68, as shown in FIG. 5. Said differently, the plurality of rods 72, the first end cap 66, and the second end cap 68 may be integral with one another (i.e., one-piece). The plurality of rods 72, the first end cap 66, and the second end cap 68 may be formed integrally with one another. The step of molding the first end cap 66 and the second end cap 68 may include molding the plurality of rods 72 such that the plurality of rods 72 are integral with the first end cap 66 and the second end cap 68.

The plurality of rods 72 may comprise a polymeric material. In the embodiments where the first spacer 38, and optionally the sleeve 48, comprises a polymeric material and the first end cap 66, the second end cap 68, and/or the plurality of rods 72 comprise a polymeric material, it is to be appreciated that these polymeric materials may be the same as each other. In non-limiting examples, the polymeric material of the plurality of rods 72 may be a thermoplastic, a thermoset, or an elastomer. The polymeric material of the plurality of rods 72 may be an engineering plastic.

More specifically, the polymeric material of the plurality of rods 72 may be, but is not limited to, any polyalkene or polyolefin including copolymers and terpolymers thereof such as polyethylene including high-density polyethylene (HDPE) and low-density polyethylene (LDPE), polypropylene (PP), polybutylene and polybutylene terephthalate (PBTR), acrylics such as acrylonitrile butadiene styrene (ABS) or polymethylmethacrylate (PMMA), polyoxymethylene (POM) or any acetal copolymers or acetal terpolymers, polyketones, polyetherketones, and/or polyaryletherketones such as polyetheretherketone (PEEK) and polyetherketoneketone (PEKK), polyetherimide (PEI), polyimides, polyvinylchloride (PVC), polyphenylene sulfide (PPS), polyphenylene oxide (PPO), polysulphone (PSU), polytetrafluoroethylene (PTFE), polyamides including polyphthalamide, polycarbonates, urethanes, epoxies, and thermoplastic elastomers (TPE).

Although not required, the polymeric material of the plurality of rods 72 may be molded, such as over-molded, insert molded, injection molded, compression molded, and thermoformed. The method 200 may further include the step of molding the plurality of rods 72. The step of molding the plurality of rods 72 may be concurrent (i.e., at the same time as) the step of molding the first end cap 66 and the second end cap 68. In other words, the first end cap 66, the second end cap 68, and the plurality of rods 72 may be molded together. Moreover, although not required, the first spacer 38, optionally incorporated into the sleeve 48, the first end cap 66, the second end cap 68, and the plurality of rods 72 may all be molded together. Alternatively, the first end cap 66, the second end cap 68, and the plurality of rods 72 may be molded together after the first spacer 38, optionally incorporated into the sleeve 48, has been molded. It is to be appreciated that molding the plurality of rods 72 may include any of molding-in-place, over-molding, insert-molding, injection molding, compression molding, and thermoforming.

Additionally, the plurality of rods 72 may be non-magnetic, may be conductive to electricity, and may further include carbon fiber. It is to be appreciated that the first end cap 66 and/or the second end cap 68 may also be non-magnetic, may be conductive to electricity, and may further include carbon fiber. It is also to be appreciated that the plurality of rods may comprise the second composition. In other words, the first end cap 66, the second end cap 68, and the plurality of rods 72 may all comprise the second composition.

The method 200 may further comprise the step of disposing the plurality of rods 72 in the plurality of channels 70 such that the plurality of rods 72 is unitary with the first end cap 66 and the second end cap 68. In some embodiments, the step of disposing the plurality of rods 72 in the plurality of channels 70 such that the plurality of rods 72 is unitary with the first end cap 66 and the second end cap 68 includes molding the plurality of rods 72, the first end cap 66, and the second end cap 68. Although not required, the step of disposing the plurality of rods 72 in the plurality of channels 70 such that the plurality of rods 72 is unitary with the first end cap 66 and the second end cap 68 may come after the step of disposing the shaft 40 within the lamination stack 24. It is to be appreciated that the step of disposing the plurality of rods 72 in the plurality of channels 70 such that the plurality of rods 72 is unitary with the first end cap 66 and the second end cap 68 may follow immediately after the step of disposing the shaft 40 within the lamination stack 24, or there may be intervening step(s) therebetween.

The first end cap 66 has a first end cap outer surface 74 facing away from the axis and the second end cap 68 has a second end cap outer surface 76 facing away from the axis A1. Although not required, the outer sleeve surface 58, the first end cap outer surface 74, and the second end cap outer surface 76 may be flush with one another, as shown in FIGS. 2 and 3. Said differently, the outer sleeve surface 58, the first end cap outer surface 74, and the second end cap outer surface 76 may all extend the same radial distance away from the axis A1 and may form a single continuous surface. Additionally, the single continuous surface formed by the outer sleeve surface 58, the first end cap outer surface 74, and the second end cap outer surface 76 may not deviating from the same radial distance away from the axis A1 as the first end cap 66, the outer sleeve body 50, and the second end cap 68 extend along the axis A1. A single, continuous surface aids in manufacturability and aerodynamic performance of the rotor assembly 20. The method 200 may include molding the first end cap 66, the second end cap 68, and the sleeve 48 such that the outer sleeve surface 58, the first end cap outer surface 74, and the second end cap outer surface 76 are flush with one another.

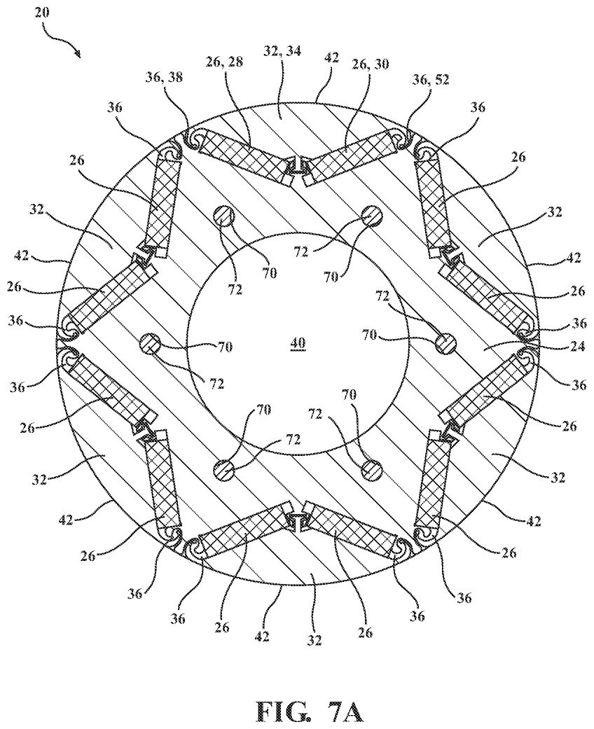

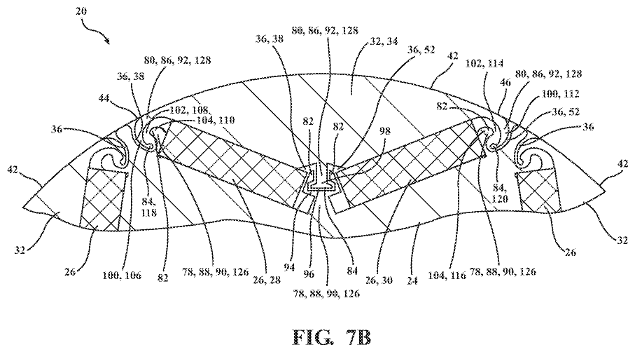

Turning now to FIGS. 7A-8, the lamination stack 24 may have a lamination retainer 78 and the first pole piece 34 may have a pole retainer configured to mechanically cooperate with the lamination retainer 78 of the lamination stack 24 to retain the first pole piece 34 with respect to the lamination stack 24. Mechanical cooperation of the lamination retainer 78 of the lamination stack 24 and the pole retainer 80 of the first pole piece 34 limits movement of the first pole piece 34 with respect to the lamination stack 24. More specifically, mechanical cooperation of the lamination retainer 78 of the lamination stack 24 and the pole retainer 80 of the first pole piece 34 limits radial movement of the first pole piece 34 with respect to the lamination stack 24. The method 200 may further comprise the step of engaging the lamination retainer 78 and the pole retainer 80 to retain the first pole piece 34 with respect to the lamination stack 24. The step of engaging the lamination retainer 78 and the pole retainer 80 to retain the first pole piece 34 with respect to the lamination stack 24 may precede the step 204 of disposing the first spacer 38 between the lamination stack 24 and the first pole piece 34.

Mechanical cooperation between the pole retainer 80 and the lamination retainer 78 need not require direct contact between the pole retainer 80 and the lamination retainer 78. The pole retainer 80 and the lamination retainer 78 may not be in contact with one another. In a non-limiting example, there may an intervening component disposed between the pole retainer 80 and the lamination retainer 78 while still permitting the pole retainer 80 to mechanically cooperate with the lamination retainer 78 to retain the first pole piece 34 with respect to the lamination stack 24. More specifically, the first spacer 38 may be disposed between the lamination retainer 78 of the lamination stack 24 and the pole retainer 80 of the first pole piece 34. Disposing the first spacer 38 between the lamination retainer 78 and the pole retainer 80 increases the strength of the mechanical cooperation between the pole retainer 80 and the lamination retainer 78 by reducing or eliminating any gaps or voids between the pole retainer 80 and the lamination retainer 78.

The method 200 may further include the step of disposing the first spacer 38 between the lamination retainer 78 and the pole retainer 80. It is to be appreciated that the step of disposing the first spacer 38 between the lamination retainer 78 and the pole retainer 80 may be concurrent (i.e., at the same time as) the step 204 of disposing the first spacer 38 between the lamination stack 24 and the first pole piece 34, and/or the step of molding the first spacer 38.

The lamination retainer 78 has a lamination retainer end 82, and the pole retainer 80 has a pole retainer end 84. The pole retainer end 84 may be disposed radially inward relative to the lamination retainer end 82. The lamination retainer end 82 may be the terminus of the lamination retainer 78, and the pole retainer end 84 may be the terminus of the pole retainer 80. Disposing the pole retainer end 84 radially inward relative to the lamination retainer end 82 restricts the movement of the first pole piece 34 relative to the lamination stack 24. More specifically, if the first pole piece 34 were to be moved radially away from the lamination stack 24, the pole retainer end 84 may contact either the lamination retainer end 82 directly or may contact an intervening component, such as the first spacer 38, which contacts the lamination retainer end 82. In so doing, the pole retainer end 84 and the lamination retainer end 82 prevents the first pole piece 34 from moving radially away from the lamination stack 24.

In some embodiments, the lamination retainer 78 and the pole retainer 80 are disposed between the first magnet 28 and the second magnet 30. In the embodiments where the lamination retainer 78 and the pole retainer 80 are disposed between the first magnet 28 and the second magnet 30, the mechanical cooperation retaining the first pole piece 34 to the lamination stack 24 occurs approximately equidistantly between the first circumferential end 44 of the first pole piece 34 and the second circumferential end 46 of the first pole piece 34. As such, the mechanical cooperation retaining the first pole piece 34 to the lamination stack 24 occurs at the approximate circumferential center of mass of the first pole piece 34, thus preventing either of the first circumferential end 44 of the first pole piece 34 and the second circumferential end 46 of the first pole piece 34 from moving further away from the lamination stack 24 as compared to the other of the first and second circumferential ends 44, 46.

In other embodiments, the pole retainer 80 is disposed at the first circumferential end 44 of the first pole piece 34. It is to be appreciated that pole retainer 80 may also be disposed at the second circumferential end 46 of the first pole piece 34. The pole retainer 80 may also be further defined as a first pole retainer 86, the lamination retainer 78 may also be further defined as a first lamination retainer 88, and the lamination stack 24 may further have a second lamination retainer 90 and the first pole piece 34 may further have a second pole retainer 92. The second pole retainer 92 of the first pole piece 34 may be disposed at the second circumferential end 46 of the first pole piece 34, and the second pole retainer 92 may be configured to mechanically cooperate with the second lamination retainer 90 of the lamination stack 24 to retain the first pole piece 34 with respect to the lamination stack 24.

The method 200 may further include the step of engaging the second lamination retainer 90 and the second pole retainer 92 to retain the first pole piece 34 with respect to the lamination stack 24. In the embodiments where the first pole retainer 86 is disposed at the first circumferential end 44 of the first pole piece 34 and the second pole retainer 92 is disposed at the second circumferential end 46 of the first pole piece 34, the mechanical cooperation retaining the first pole piece 34 to the lamination stack 24 occurs both at the first circumferential end 44 of the first pole piece 34 and at the second circumferential end 46 of the first pole piece 34. Two separate and circumferentially spaced locations of mechanical cooperation strengthen the retention of the first pole piece 34 to the lamination stack 24. More specifically, two separate and circumferentially spaced locations of mechanical cooperation limits the relative amount of pivoting of the first pole piece 34 relative to the lamination stack 24.

In one embodiment, one of the lamination retainer 78 and the pole retainer 80 has a generally C-shaped configuration 94 defining a channel 96, and the other of the lamination retainer 78 and the pole retainer 80 has a generally T-shaped configuration 98 disposed at least partially in the channel 96. In other words, as shown in FIGS. 7A and 7B, the lamination retainer 78 may have the generally C-shaped configuration 94 and the pole retainer 80 may have the generally T-shaped configuration 98, or the lamination retainer 78 may have the generally T-shaped configuration 98 and the pole retainer 80 may have the generally C-shaped configuration 94. The method 200 may further include the step of disposing the generally T-shaped configuration 98 at least partially in the channel 96 defined by the generally C-shaped configuration 94.

In another embodiment, as shown in FIGS. 7A and 7B, the pole retainer 80 includes a pole hook 100 defining a hook recess 102, and the lamination retainer 78 includes a lamination hook 104 extending at least partially into the hook recess 102 defined by the pole hook 100 to retain the first pole piece 34 to the lamination stack 24. The method 200 may further include the step of disposing the lamination hook 104 at least partially into the hook recess 102 defined by the pole hook 100 to retain the first pole piece 34 to the lamination stack 24.

In the embodiments where the rotor assembly 20 includes first and second pole retainers 86, 92 and first and second lamination retainers 88, 90, the first pole retainer 86 may include a first pole hook 106 defining a first hook recess 108 and the first lamination retainer 88 may include a first lamination hook 110. In these embodiments, the second pole retainer 92 may include a second pole hook 112 defining a second hook recess 114, and the second lamination retainer 90 may include a second lamination hook 116 extending at least partially into the second hook recess 114 defined by the second pole hook 112 to retain the first pole piece 34 to the lamination stack 24. The first pole hook 106 may have a first hook end 118 and the second pole hook 112 may have a second hook end 120, and the first hook end 118 of the first pole hook 106 and the second hook end 120 of the second pole hook 112 may extend toward one another to increase the strength of the retention of the first pole piece 34 to the lamination stack 24. It is to be appreciated that the first hook end 118 may be the terminus of the first pole hook 106 and the second hook end 120 may be the terminus of the second pole hook 112. The method 200 may further include the step of disposing the second lamination hook 116 at least partially into the second hook recess 114 defined by the second pole hook 112 to retain the first pole piece 34 to the lamination stack 24.

As shown in FIG. 8, at least one of the lamination retainer 78 and the pole retainer 80 may have a generally mushroom-shaped configuration 122, and the other of the lamination retainer 78 and the pole retainer 80 may form a complimentary retainer recess 124. In other words, as shown in FIG. 8, the lamination retainer 78 may have the generally mushroom-shaped configuration 122 and the pole retainer 80 may form the retainer recess 124. Alternatively, the lamination retainer 78 may form the retainer recess 124 and the pole retainer 80 may have the generally mushroom-shaped configuration 122. The generally mushroom-shaped configuration 122 of either the lamination retainer 78 or the pole retainer 80 may contact the first magnet 28 and the second magnet 30, either directly or through an intervening component such as the first spacer 38, to assist in retaining the first and second magnets 28, 30. Moreover, the first spacer 38 may be disposed in the retainer recess 124 to further retain the first pole piece 34 relative to the lamination stack 24. The method 200 may further include contacting the generally-mushroom shaped configuration 122 of either of the lamination retainer 78 and the pole retainer 80 with the first and second magnets 28, 30 to assist in retaining the first and second magnets 28, 30.

It is to be appreciated that the rotor assembly 20 may further include a third lamination retainer 126 and a third pole retainer 128. The third lamination retainer 126 may have any of the characteristics of any of the lamination retainers as described herein, and the third pole retainer 128 may have any of the characteristics of any of the pole retainers as described herein. The method 200 may further include the step of engaging the third lamination retainer 126 and the third pole retainer 128 to retain the first pole piece 34 with respect to the lamination stack 24

The plurality of pole pieces 32 may include two pole pieces, three pole pieces, four pole pieces, five pole pieces, six pole pieces, seven pole pieces, eight pole pieces, nine pole pieces, ten pole pieces, or more than ten pole pieces. The plurality of magnets may include four magnets, six magnets, eight magnets, ten magnets, twelve magnets, fourteen magnets, sixteen magnets, eighteen magnets, twenty magnets, or more than twenty magnets. The plurality of channels 70 and the plurality of rods 72 may include two channels and two rods, three channels and three rods, four channels and four rods, five channels and five rods, six channels and six rods, seven channels and seven rods, eight channels and eight rods, nine channels and nine rods, ten channels and ten rods, eleven channels and eleven rods, twelve channels and twelve rods, thirteen channels and thirteen rods, fourteen channels and fourteen rods, fifteen channels and fifteen rods, sixteen channels and sixteen rods, seventeen channels and seventeen rods, eighteen channels and eighteen rods, nineteen channels and nineteen rods, twenty channels and twenty rods, or more than twenty channels and more than twenty rods. Each pole piece 32 may define one channel, may define two channels, may define three channels, or may define more than three channels. The lamination stack 24 may also define the plurality of channels 70, and may define one channel, two channels, three channels, four channels, five channels, six channels, seven channels, eight channels, nine channels, ten channels, or more than ten channels.

The rotor assembly 20 may be configured to rotate at rotational speeds above 20,000 rotations per minute (RPM). In non-limiting examples, the rotor assembly 20 may be configured to rotate between about 20,000 RPM and about 50,000 RPM, between about 20,000 RPM and about 40,000 RPM, between about 20,000 RPM and about 30,000 RPM, and between about 20,000 RPM and about 25,000 RPM. In some embodiments, the sleeve 48 is capable of retaining the plurality of pole pieces 32 to the lamination stack 24 at rotational speeds at, or in excess of, 20,000 RPM. In other embodiments, the lamination retainer 78 and the pole retainer 80 are capable of retaining the plurality of pole pieces 32 to the lamination stack 24 at rotational speeds at, or in excess of, 20,000 RPM. As such, the rotor assembly 20 may be considered a high-speed rotor assembly.

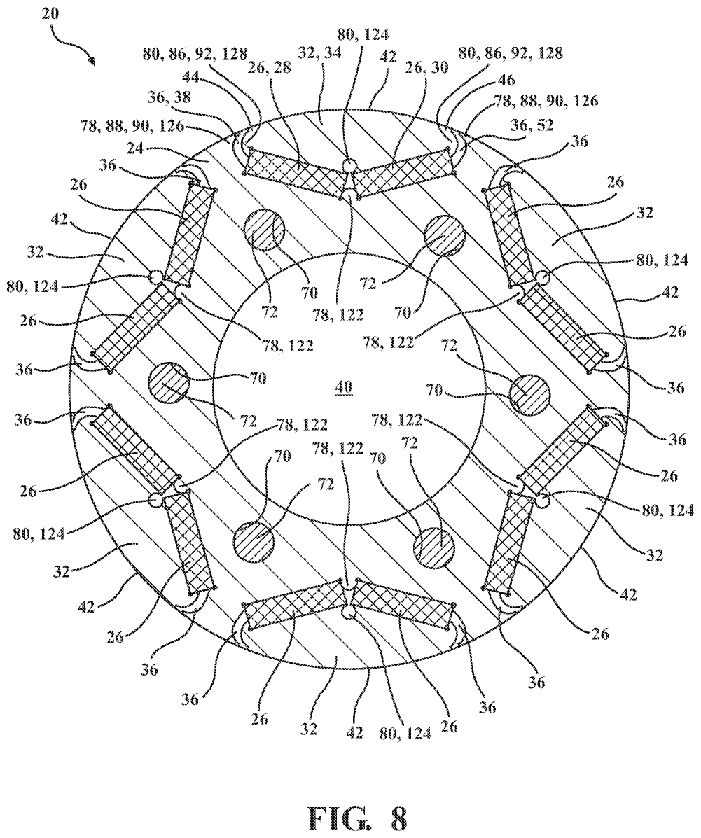

The rotor assembly 20 may be incorporated into an electric motor 22, as shown in FIG. 9. The electric motor 22 includes a stator 130 extending along the axis A1 and defining a stator interior 132, and the rotor assembly 20 may be disposed in the stator interior 132 of the stator 130. The rotor assembly 20 may be disposed completely within the stator interior 132 of the stator 130, or the rotor assembly 20 may be disposed only partially within the stator interior 132 of the stator 130. A method of manufacturing the electric motor includes the step of manufacturing the rotor assembly 20 and the step of disposing the rotor assembly 20 in the stator interior 132 of the stator 130.

The stator 130 may include coil windings 134 that may be energized to generate the magnetic flux detailed herein. The plurality of spacers 36 increases the efficiency of the electric motor 22 by reducing the amount of the magnetic flux that is leaked, thus increasing the efficiency of force imparted to rotate the rotor assembly 20 relative to the amount of magnetic flux required to be generated.

Moreover, a gap may be defined between either the outer sleeve surface 58 of the sleeve 48 or the outer pole surface 42 of the first pole piece 34 and the stator interior 132 of the stator 130. It is advantageous to reduce this gap to the extent possible to minimize losses due to air friction. It is to be appreciated that the sleeve 48 may be manufactured with relatively tight tolerances, thus permitting a relatively small gap to be defined either between the outer sleeve surface 58 of the sleeve 48 and the stator interior 132 of the stator 130 or between the outer pole surface 42 of the first pole piece 34 and the stator interior 132 of the stator 130, and thus also minimizing losses due to air friction. The gap may between XX millimeters and XX millimeters.

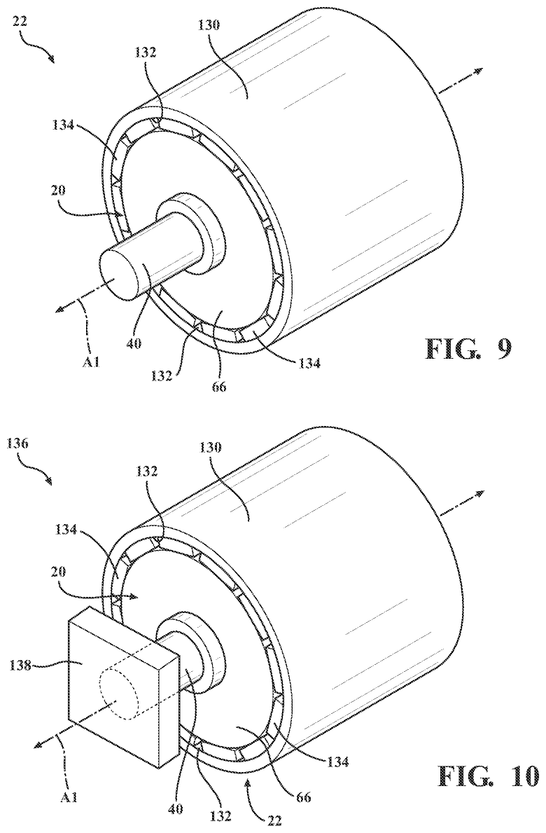

As shown in FIG. 10, the electric motor 22 is incorporated into an electric drive unit 136. The electric drive unit 136 includes the electric motor 22 and a gear reduction mechanism 138 coupled to the shaft 40 of the rotor assembly 20. The gear reduction mechanism 138 may be configured to modulate torque received from the shaft 40. The gear reduction mechanism 138 may be, but is not limited to, a planetary gearset, a reduction gearbox such as a two-stage reduction gearbox, a worm gear reducer, a helical gear reducer, a spur gear reducer, a hypoid gear reducer, a bevel gear reducer, a gear train gear reducer, a cycloidal gear reducer, a magnetic gear reducer, an orthogonal gear reducer, a skew axes gear reducer, a parallel shaft gear reducer, a coaxial gear reducer, and combinations thereof. A method of manufacturing the electric drive unit 136 includes the step of manufacturing the electric motor 22 and the step of coupling the electric motor 22 to the gear reduction mechanism 138. More specifically, the step of coupling the electric motor 22 to the gear reduction mechanism 138 may include coupling the shaft 40 of the rotor assembly 20 to the gear reduction mechanism 138.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A method of manufacturing a rotor assembly for an electric motor, the rotor assembly including a lamination stack extending along an axis, a plurality of magnets including a first and second magnet each coupled to the lamination stack, a plurality of pole pieces including a first pole piece spaced from the lamination stack and separate from the lamination stack, and a plurality of spacers including a first spacer spaced from the lamination stack, said method comprising the steps of:
disposing the first magnet and the second magnet between the lamination stack and the first pole piece; and
disposing the first spacer between the lamination stack and the first pole piece to reduce flux leakage between the lamination stack and the first pole piece.

2. The method as set forth in claim 1, wherein the step of disposing the first spacer between the lamination stack and the first pole piece includes disposing the first spacer such that the first spacer extends at least to the first magnet.

3. The method as set forth in claim 1, wherein the step of disposing the first spacer between the lamination stack and the first pole piece includes disposing the first spacer such that the first spacer is disposed between the first magnet and the second magnet.

4. The method as set forth in claim 1 further comprising the step of disposing a shaft within the lamination stack such that the shaft extends along the axis.

5. The method as set forth in claim 1, wherein the first spacer comprises a polymeric material, and wherein the step of disposing the first spacer between the lamination stack and the first pole piece includes molding the first spacer such that the first spacer is disposed between the lamination stack and the first pole piece.

6. The method as set forth in claim 1, wherein the step of disposing the first magnet and the second magnet between the lamination stack and the first pole piece precedes the step of disposing the first spacer between the lamination stack and the first pole piece.

7. The method as set forth in claim 1, wherein the first pole piece has a first circumferential end and a second circumferential end spaced circumferentially from the first circumferential end, and has an outer pole surface facing away from the axis and extending between the first and second circumferential ends, and wherein the step of disposing the first spacer between the lamination stack and the first pole piece includes disposing the first spacer circumferentially between the first circumferential end of the first pole piece and the lamination stack.

8. The method as set forth in claim 1, wherein the lamination stack extends along the axis between a first lamination stack end and a second lamination stack end, wherein the rotor assembly further comprises a first end cap adjacent to the first lamination stack end and a second end cap adjacent to the second lamination stack end, and wherein the first end cap and the second end cap comprise a polymeric material, and said method further comprises the step of molding the first end cap and the second end cap.

9. The method as set forth in claim 8, wherein the first spacer comprises a polymeric material, wherein the step of disposing the first spacer between the lamination stack and the first pole piece includes molding the first spacer such that the first spacer is disposed between the lamination stack and the first pole piece, and wherein the step of molding the first end cap and the second end cap is concurrent with the step of molding the first spacer such that the first end cap and second end cap are unitary with the first spacer.

10. The method as set forth in claim 8, wherein the first spacer comprises a polymeric material, wherein the step of disposing the first spacer between the lamination stack and the first pole piece includes molding the first spacer such that the first spacer is disposed between the lamination stack and the first pole piece, and wherein the step of molding the first end cap and the second end cap is separate from the step of molding the first spacer.

11. The method as set forth in claim 10, wherein the first spacer has a first composition, and wherein at least one of the first end cap and the second end cap has a second composition different from the first composition of the first spacer.

12. The method as set forth in claim 8, wherein the lamination stack defines a plurality of channels between the first lamination stack end and the second lamination stack end, and further comprising the step of disposing a plurality of rods in the plurality of channels such that the plurality of rods is unitary with the first end cap and the second end cap.

13. The method as set forth in claim 1, wherein each pole piece of the plurality of pole pieces has an outer pole surface facing away from said axis, wherein the step of disposing the first spacer between the lamination stack and the first pole piece further includes coupling a sleeve to the lamination stack, the sleeve including an outer sleeve body and the first spacer extending from the outer sleeve body radially inward toward the axis, wherein coupling the sleeve to the lamination stack includes disposing the outer sleeve body about the outer pole surface of each pole piece of the plurality of pole pieces to retain each of the pole pieces with respect to the lamination stack.

14. The method as set forth in claim 1, wherein the lamination stack has a lamination retainer and the first pole piece has a pole retainer configured to mechanically cooperate with the lamination retainer, and said method further comprises the step of engaging the lamination retainer and the pole retainer to retain the first pole piece with respect to the lamination stack.

15. The method as set forth in claim 14 further comprising the step of disposing the first spacer between the lamination retainer and the pole retainer.

16. The method as set forth in claim 14, wherein one of the lamination retainer and the pole retainer has a generally C-shaped configuration defining a channel and the other of the lamination retainer and the pole retainer has a generally T-shaped configuration, and said method further comprises the step of disposing the generally T-shaped configuration at least partially in the channel defined by the generally C-shaped configuration.

17. The method as set forth in claim 14, wherein the pole retainer includes a pole hook defining a hook recess and the lamination retainer includes a lamination hook, and said method further comprises the step of disposing the lamination hook at least partially into the hook recess defined by the pole hook to retain the first pole piece to the lamination stack.

18. The method as set forth in claim 14, wherein the pole retainer is further defined as a first pole retainer, wherein the lamination retainer is further defined as a first lamination retainer, wherein the lamination stack further has a second lamination retainer, wherein the first pole piece further has a second pole retainer disposed at the second circumferential end of the first pole piece and configured to mechanically cooperate with the second lamination retainer, and said method further comprises the step of engaging the second lamination retainer and the second pole retainer to retain the first pole piece with respect to the lamination stack.

19. A method of manufacturing an electric motor, the electric motor including a stator defining a stator interior, said method comprising the steps of:
manufacturing the rotor assembly as set forth in claim 1; and
disposing the rotor assembly in the stator interior of the stator.

20. A method of manufacturing an electric drive unit, the electric drive unit including a gear reduction mechanism, said method comprising the steps of:
manufacturing the electric motor as set forth in claim 19; and
coupling the electric motor to the gear reduction mechanism.
